(19) United States
(12) Patent Application Publication
(10) Pub. No.: US 2005/0033604 A1
(43) Pub. Date: Feb. 10, 2005

(54) Method and apparatus for settling claims between health care providers and third party payers

(75) Inventor: Brian F. Hogan, Pembroke Pines, FL (US)

Correspondence Address: RUDEN, MCCLOSKY, SMITH, SCHUSTER & RUSSELL, P.A., P.O. BOX 1900, FORT LAUDERDALE, FL, 33301, US

(73) Assignee: Mitan Technologies, LLC

(21) Appl. No.: 10/651,891

(22) Filed: Aug. 29, 2003

Related U.S. Application Data
(63) Continuation-in-part of application No. 09/615,547, filed on Jul. 13, 2000, now abandoned.
(60) Provisional application No. 60/143,448, filed on Jul. 13, 1999.
(60) Provisional application No. 60/168,000, filed on Nov. 30, 1999.

(51) Int. Cl. G06F 17/60

(52) U.S. Cl. 705/2; 705/40

(57) ABSTRACT

A method for effectuating payment of a service for the benefit of a first party, performed by a second party and facilitated by a third party, comprising first party requesting a service from a second party; a first party providing relationship information about the first party's relationship with the third party to the second party; the second party electronically communicating the relationship information to a third party to verify eligibility of the first party; the third party confirming eligibility of the first party in an asynchronous real-time mode and providing a predetermined fee schedule between the third party and the second party for services for the first party; the second party submitting a claim, based on services for the first party, to the third party; comparing the submitted claim to the relationship information concerning the first party's relationship with the third party, and adjudicating the claim in an asynchronous real-time mode and settling the claim by the third party authorizing a transfer of funds to the second party when the compared information is within guidelines established by the third party.

### CROSS-REFERENCES TO RELATED APPLICATIONS

This application is a Continuation-In-Part of U.S. patent application Ser. No. 09/615,547, filed on Jul. 13, 2000, entitled METHOD AND APPARATUS FOR SETTLING CLAIMS BETWEEN HEALTH CARE PROVIDERS AND THIRD PARTY PAYERS USING A SMART CARD ID CARD, which claims the benefit of U.S. Provisional Application No. 60/143,448 filed Jul. 13, 1999; and No. 60/168,000 filed Nov. 30, 1999. These provisional applications are incorporated herein by reference.

### TECHNICAL FIELD OF INVENTION

The present invention is a business method and apparatus for adjudicating and effecting payment of claims between providers of health care and third party payers utilizing credit card administration. The System connects health care providers, third party payers and credit card processors in an asynchronous real-time processing mode environment, to provide fully automated adjudication and payment processing of medical claims and tracking of critical claims data.

### BACKGROUND OF THE INVENTION

Presently, in the health care industry, total annual health claims processed in the private sector amount to $600 billion. Another $600 billion in Medicaid and Medicare claims are administered by 36 private sector Managed Care Organizations (MCO's) for an approximate total of $1.2 trillion annually in healthcare expenditures. The health care industry is in transition towards consolidation; the industry recognizes the need to reduce operating expenses and more accurately manage claim data in order to increase profitability. MCO's are becoming less vertically integrated—they have outsourced many functions in an effort to become more efficient. The core business of the MCO's includes processing claims, managing medical and other costs, pricing, marketing, and underwriting benefit plan designs. To date, most efforts to incorporate recent technological advances into claims processing have been limited to encouraging the electronic submission of claim data by providers, via electronic data interchange. This would include for example direct wire connection on a private electronic network and batch processing using electronic media. The insurance industry is now investing heavily in information and technology on the world wide computer information network.

The traditional insurance claim process is best shown by referring to FIG. 1. A client or patient seeks services or goods (see line 101) from a health care provider and presents insurance identification. The provider attempts to confirm (see line 102) eligibility (primarily a verification that the policy is in force) of insurance by telephone or fax contact with the client's insurance company as instructed on the client's insurance identification card. If the provider is unable to confirm eligibility of benefits, the provider will likely seek alternate forms of payment for service and the patient must manually seek reimbursement from the insurance company. If the provider can obtain eligibility for insurance, it must then be determined if other contractual terms will impede reimbursement. If the provider is confident that insurance will reimburse the services, then the provider treats the patient on the strength of the credit provided by the insurance company.

The services are then rendered to the client and the provider submits a claim (see line 103) to the client's insurance company by mail. The insurance company will adjudicate the claim and mail a check for the eligible expenses to the provider. The claim reimbursement after adjudication of the claim in the form of a check is typically a partial payment of the submitted claim amount because of, e.g., the deductibles, the co-payments and/or, but not limited to, the fee exceeding the contractual limits of the patient's policy.

The provider compares the covered expenses with the original charges, and if necessary, bills the balance (line 104) to the patient/client. The client then reimburses the provider or forces the provider to open a delinquent account. Presently, it is believed that at least 80%, of balance bills subsequently billed to the patient/client, remain uncollected. Typically, the doctor will ultimately write off this balance, bill a portion, or turn it over to a third party collection agency. This, of course, does not build goodwill for the doctor or in the doctor's community. Furthermore, in the prior art, the communication between the client, the provider, and the insurance company is by telephone or facsimile or by mail.

As an alternative, it is also possible to couple the insurer's and the provider's computer systems. The insurer typically has a mainframe or network computer system. The provider would generate the pertinent data for a patient, and then transmit that data to the insurer's computer system via a modem. The provider could then use its computer to obtain any insurance information from the insurer's system via a modem.

One particular problem in this alternative is developing a suitable interface to couple the provider's Office Management System (“OMS”) and the insurer's system. Many OMS systems are proprietary or UNIX based and the developer of the OMS system is often unwilling to develop a suitable interface for insurers. Another problem is the additional hardware that may be needed to support a network interface between the insurer and the provider's OMS. Such an interface may require additional ports and hardware enhancements, including additional memory and disk drives. The provider may be unwilling to pay for such hardware. Furthermore, in some cases, in order to add a node to the OMS network, the insurer may have to add eight ports just to obtain one interface to the OMS system.

As a consequence, claims forms including patient information are usually retrieved by courier and taken to a branch facility wherein the patient data is entered into the insurer's computer system, or, alternatively, transmitted from the provider to the insurer in so-called “real-time processing.”

The major shortcoming to such attempts to integrate the systems of insurers and providers is the inability to engage in truly real-time processing. Real-time processing systems have three basic requirements: 1) the ability to capture data, 2) the ability to translate data, and 3) the ability to conduct a protocol-invoking batch process transaction in real-time. Real-time processing describes a process in that as data is written to a database, such as the provider system, the change is also performed on the insurer system. This can be an insert, modification, or deletion of a data row or record. There are two types of real-time processing: synchronous and asynchronous. With synchronous real-time processing, both the provider database write and the insurer database write are completed before further processing occurs. An example of such synchronous real time processing in the prior art is disclosed in U.S. Pat. No. 4,491,725 to Pritchard. Asynchronous real-time processing, as in the present invention, is for relational databases and can be performed with minimal overhead. In the present invention, the application program writes a transaction to a log file (or database table) every time an update occurs. Concurrently, a background process reads transactions from the file and performs the necessary update to the indexes. The transaction can be logged via a database trigger. At any particular time, the background process may lag behind the primary update process in performing index updates, but eventually it catches up to the primary update process. Thus, the indexing is performed asynchronously in real-time.

Asynchronous real-time distributed computing systems are extremely important for real-time control above the device-level in many industries, including defense, industrial automation, and telecommunications. The prior art insurance adjudication systems, including U.S. Pat. No. 4,491,725 to Pritchard, fail to include the above-mentioned basic requirements, particularly the use of a protocol-invoking batch process transaction in asynchronous real-time, and thus do not engage in real-time processing of claim information.

### SUMMARY OF THE INVENTION

The present invention is a method and apparatus for adjudicating and effecting payment of claims between health care providers and health care third party payers utilizing credit card administration systems. Health care providers means doctors, hospitals, drug stores and parties expecting to submit a claim to an insurance company for payment for services rendered or goods provided. Third party payers include the insurance company, HMO or a preferred provider organization such as, e.g., Aetna®, and Blue Cross/Blue Shield® (registered trademarks of Aetna Life and Casualty Company and blue Cross/Blue Shield Association, respectively).

Immediate claim adjudication, as used herein, means the review and determination of the amount of payment contemplated by the insurance agreement between the parties, the actual amount further depends on the insurance agreement between the parties since the doctor's bill may be, for example, $125 and pursuant to the agreement between the insurance company and the injured, the injured may pay a fractional amount such as 80%, or the sum may be adjusted by a deductible amount, in which case the case is adjudicated and, thus, “adjudicated” may mean accepting or rejecting the claim in whole or in part by the insurance company.

Unique to this approach in the present invention is an innovation System interface that links health care providers with an intermediary database system and health insurance claim systems. This System significantly enhances performance of heath care system while dramatically reducing administrative costs.

As used herein, Current Procedural Terminology (CPT) is a listing of descriptive terms and identifying codes for reporting medical services and procedures. The purpose of CPT is to provide a uniform language that accurately describes medical, surgical and diagnostic services, and thereby serves as an effective means for reliable nationwide communication among physicians, patients and third parties.

CPT descriptive terms and identifying codes was first developed and published in 1966 by the American Medical Association. It currently serves a wide variety of important functions. This work of terminology is the most widely accepted medical nomenclature used to report medical procedures and services under public and private health insurance programs. CPT is also used for administrative management purposes such as claims processing and developing guidelines for medical care review.

In the insurance industry, health and other insurances are offered under organizations called preferred provider organizations or PPO's.

A PPO makes arrangements for lower fees with a network of health care providers. PPO's give their policy holders a financial incentive to stay within that network.

For example, a visit to an in-network doctor might mean the patient has a $10 “co-pay”. If the patient wanted to see an out-of-network doctor, they would have to pay the entire bill up front and then submit the bill to their insurance company for an 80% reimbursement. In addition, they might have to pay a deductible if they were to choose to go outside the network, or pay the difference between what the in-network and out-of-network doctors charge.

With a PPO, they can refer themselves to a specialist without getting approval and, as long as it's an in-network provider, enjoy the same “co-pay”. Staying within the network means less money coming out of their pocket and less paperwork.

Health care providers will access the System through a connection to a computer network, such as the world wide computer network, in their office on a computer, including a personal computer, located in the provider's offices and agree to a fixed fee schedule based on CPT codes. Most providers already participate in a PPO facilitating the implementation. The insured will provide information detailing the relationship, which will include policy, certificate holder and plan information.

An insured would present the relationship information in the form of an insurance card, which is standard operating procedure, when seeking health related service. The provider's office administrator can now confirm eligibility by checking that the insured's policy is up to date by using the same procedure that any vendor would use to confirm that a line of credit is in good standing. To do so, the insurance company provides the System with eligibility information on a real-time basis. If the policy is valid, the provider will receive an electronic confirmation of eligibility for services. If the policy is delinquent, then the default procedure is for the provider to telephone the insurance company to obtain a verbal confirmation or request alternative means of payment.

After services are provided, the administrator would again access the System, key the appropriate CPT codes for services rendered (which is numeric or alphanumeric) and the corresponding fixed fee. This step requires a link between the provider and the claim system, which is accomplished through the System interface of the present invention. The link would open the certificate holder's file, process the request and record the transaction.

The facilitator of these activities can be the asynchronous real-time System interface, including a database, on a computer network, such as the world wide computer network. The System will attempt to obtain an immediate “approval” from the insurance company's claim system. If the submitted fee agrees with the negotiated CPT code and the procedure is within the insurance policy rules, then in asynchronous real-time the claim is “approved” and funds are ultimately transferred to the provider's bank account. A written Explanation of Benefits (EOB) is automatically generated and sent to the provider and patient for their files.

As used herein, asynchronous real-time means that the response to a given situation is generally provided by the System to the requester, e.g., the provider, while the provider is on-line or otherwise connected to the System. Asynchronous real-time is the period that a reasonable person would expect an electronic authorization for a transaction, e.g., a retail credit care approval, to require. Typically, the expectation is one to three minutes but can take longer depending on electronic traffic, modem speed, etc. Exceptions will exist, such as when equipment is down or communications between equipment is slow. However, asynchronous real-time is not as exists in the present state of the art. As to the latter, such an example would include that described above in the “Related Art” section, where decisions on eligibility as used in the present system is often not known until payment is received and complete payment of claims takes considerable time, and often months.

If the CPT code does not match the submitted fee, or the procedure is not an insurable expense, then the claim is manually adjudicated by the insurance company to determine if any benefits are payable by the policy. If benefits are payable, then the insurance company advises both the provider and the insured.

The present invention allows health insurers, in association with an intermediary database server, to issue asynchronous real-time claim eligibility and adjudication to a health care services provider. The present invention replaces the current insurance reimbursement system.

The relationship information will be used to access the network based System of the present invention. At the point of service, a provider submits the relationship information to verify identification and assess a patient's eligibility that are secured by health insurance policies. The System functions as a conduit, routing the relationship information through an intermediary database to the appropriate health insurer. The health insurer then provides a confirmation or denial of the relationship information in asynchronous real-time, which is sent to the intermediary database and routed to the health care provider.

After service is provided, the doctor submits a claim for immediate approval through the System using industry standard CPT codes. The System again establishes an interface with the insurance company's claim system. The coded claim is first directed electronically to the intermediary database and then to the insurance company's claim system. The claim system advises the amount of the expenses that it will reimburse under the terms of the client's policy and then electronically forwards the data to the intermediary database, which then forwards the claim information to the health care services provider.

Leveraging its well-documented comparative advantages in processing large volumes of claims transactions, the health insurer would credit the provider's account for services in asynchronous real-time and arrange for reimbursement. Co-payments or other non-insurable expenses due the provider can be paid by the consumer directly. As to the payment by credit card, if there is sufficient credit, then payment is effected. If there is not sufficient credit, the provider is advised to seek alternate payment from the patient.

Insurance companies will significantly lower operating costs and will be able to achieve significant reductions in the cost of claims processing by implementing the System of the present invention.

The System will provide the insurer with immediate claims data, thereby reducing the “tail” of incurred but not reported claims and the greater predictability of claims, combined with more accurate treatment coding, will allow for more accurate product pricing and more stable earnings.

The health insurer will generate additional revenue through the reduction of costs associated with traditional claims eligibility and adjudication systems by utilizing the paperless asynchronous real-time system of the present invention. This relationship with System of the present invention thus represents a new revenue source for health insurers. It is anticipated that the insurers would obtain fee reductions from providers in return for the automated, rapid payment of claims. It is not anticipated that there will be a significant expense for the insurer in terms of hardware required to implement the System at the provider's office/facility. access to a computer network, such as the world wide computer network, where the System will reside is nearly universally present in medical facilities, and doctor's or other providers' offices.

The System will allow physicians to determine who his responsible for payment for medical services in an asynchronous real-time mode. They will be able to significantly reduce their overhead by reducing paperwork and back office expense associated with filing of claims and collection expenses. This will result in lower account receivables and reduced cost of carrying debit. The physicians will experience better cash flow. By immediately establishing you is financially responsible for services rendered, physicians will be able to reduce doubtful account balances. Office management will be simplified by the enhanced organization of patient and collections data the System offers. Summaries of payment information will be available on the System's web site and provided in a monthly report to the physician. The physician will be able to focus more of his time and energy on providing healthcare to his patients, his core business, and will be able to increase revenues while reducing expenses.

Patients will accept the System because it simplifies the payment process of healthcare claims. Most important, they will know which services their insurer covers at the time of service. They will no longer have to file insurance forms for reimbursement. The System is one that will be perceived as convenient.

### DESCRIPTION OF THE DRAWINGS

In the drawings that form part of the description of preferred embodiment of this invention and wherein like numbers refer to like structural elements.

FIG. 1 is a block diagram of the traditional insurance claim relationship between the first party/client/patient, the second party/provider and the third party/insurance company.

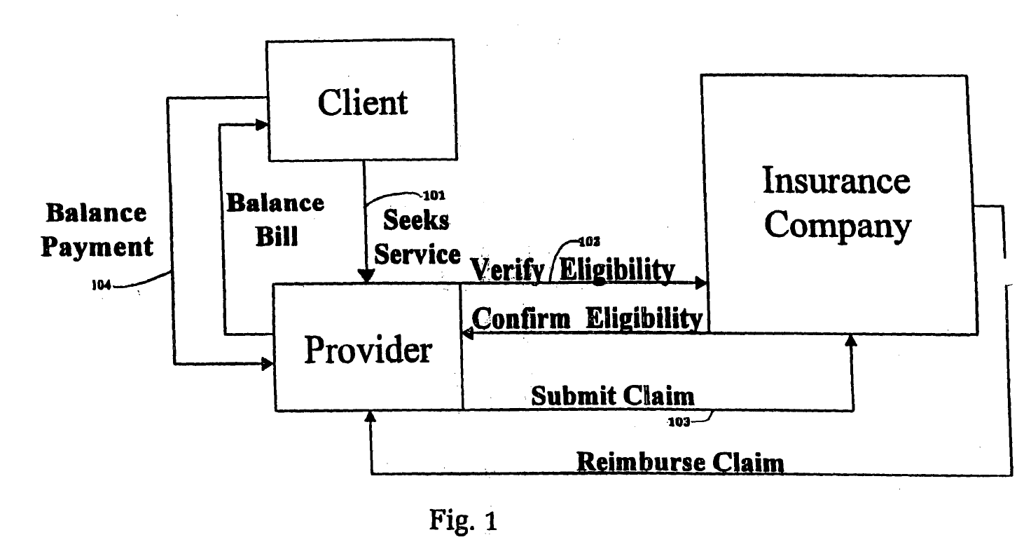

FIG. 2 is a block diagram of the relationship of the client, the provider, the insurance company and intermediary database.

FIG. 3 is a screen showing a portion of the super bill from the System as seen by a provider.

FIG. 4 is a screen showing another portion of the super bill from the System as seen by a provider.

FIG. 5 is a screen showing the super bill from the System as seen by the provider.

FIG. 6 is a screen used during sign on from the System as seen by a provider.

FIG. 7 is another screen used during sign on from the System as seen by a provider.

### DETAILED DESCRIPTION OF INVENTION

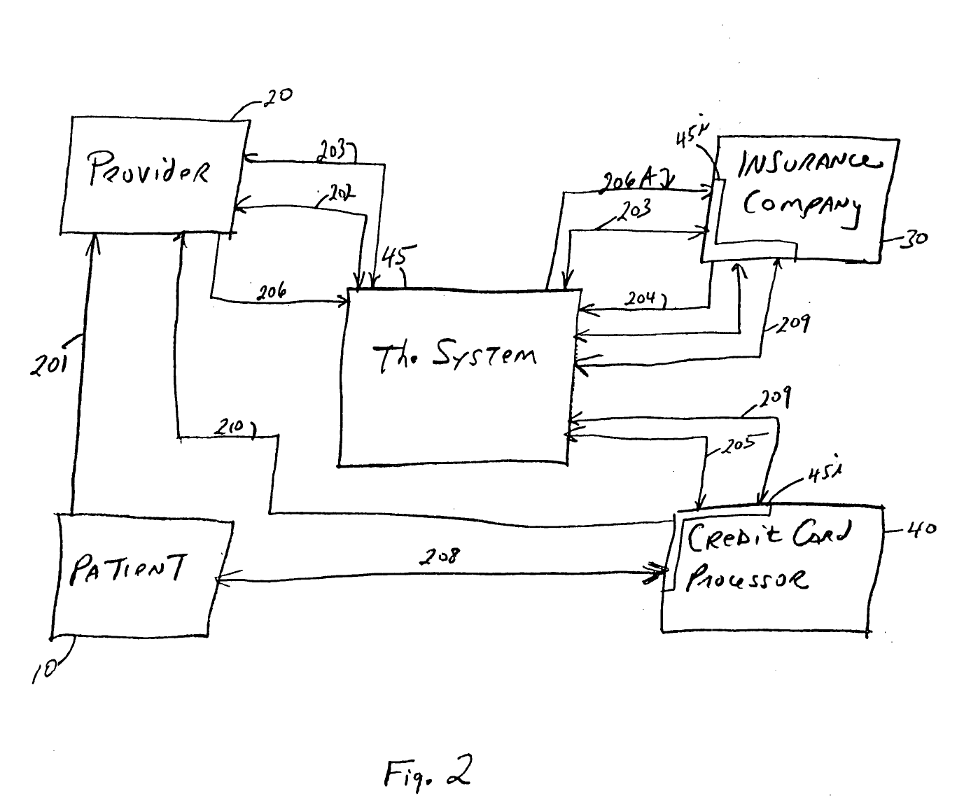

Referring to FIG. 2, a client 10 seeks services, line 201, or goods from a health care provider 20 and presents relationship information in the form of a health service card of the present invention. The present invention assumes that client 10 as already qualified and is insured by an insurance company 30, according to their normal underwriting standards. The relationship information would normally be obtained by each client patient 10 insured by an insurance company 30 in the System 45.

At the point of obtaining the services by provider 20, e.g., by the doctor in the doctor's office, the primary documentary evidence provided by client 10 to the provider 20 is in the form of the relationship information line 201. This relationship information can be entered into the provider's system by numerous ways, such as by entering the patient's I.D. number from the relationship and is communicated to the System 45, line 202. The provider 20 receives a confirmation of the eligibility of client 01, based on information sent and received back from the insurance company 30 along with an authorization from the insurance company 30, lines 203. The insurance company 30 provides the System 45 with a daily list of delinquent accounts, line 204—if the card is not identified as delinquent, then the provider 20 receives an authorization to provide services according to an agreed upon fee schedule.

The patient's/client's benefits, as provided by the insurance company, are reviewed prior to providing a confirmation of eligibility by the insurance company which are subject to an agreed upon fee schedule with the client. One of the benefits at this particular step is the minimal amount of time taken between a request by provider 20 to verify eligibility and a return response from the System 45 confirming the eligibility of client 10.

In FIG. 2, when services are rendered to the client, the provider submits a claim, line 206, which is processed by the System for immediate adjudication.

If the submitted fees agree to the CPT codes and the procedure is within the plan rules, then the claim is “approved”.

At this point in time the System communicates with the insurance company's records of the client to determine the adjudication of the provider's submitted claim. As an example, if during the visit, two procedures were performed, two codes would be entered with two corresponding fee amounts.

Assuming the first procedure,
(a) was $60 and the second procedure was $100, a total claim request by the provider to the System would have been $160. Concerning the adjudication of the amount of $160, several scenarios can take place. A few would include as follows: (1) the client's deductibles had not been met, in which case the insurance company's data would indicate to the System that the insurance company is not obligated to make the payment and the provider would be immediately advised in order for the provider to collect the amount.
(b) it is possible that the entire amount of the submitted claim charge would be paid from the insurance company's account and the System would advise the provider that the claim has been settled in full by the insurance company and payment credited to the provider on behalf of the insurance company. A confirmation would be signed by the patient which would also show a zero balance. The provider would receive a credit to his or her account pursuant to the agreement with the health care insurer, typically within 24-48 hours, as is known and practiced in the art.
(c) Some charges will be settled by the insurance company and the remaining amount will be the responsibility of the client, in which case would represent a combination of the previously described methods.

If the CPT codes for services rendered do not match, the provider must submit the claim to the insurance company for manual adjudication.

In addition, the System will determine the extent of insurance credit available to any client based on the characteristics of the members/clients 10 belonging to a participating insurance policy of insurance company 30. This will be performed using risk profile analyses. It is anticipated that by providing the data in the present System of clients to the health insurer so that the health insurer can make determinations of insurance limits for each group or subgroup of clients. It is further anticipated that in addition to providing healthcare services, that the data contained within the pool of clients as a potential pool of credit card users has value which can be offered for consideration to a credit card processor. In addition, as described above for using the retail line of credit in a provider's office, the client can also use a smart card for retail credit in any store that accepts retail credit cards. This opens the door to eliminate the client having multiple credit cards, multiple insurance cards, and multiple health I.D. cards used to buy prescription drugs, etc. (prescription drug cards, lab cards and medical cards).

The insurance company 30 agrees to have its system(s) linked to the System 45. The insurance company and providers agree to use CPT codes, and agree upon fee schedules for services rendered under the policy.

The insurance company authorizes payment on their behalf for the services according to the patient's plan, lines 209. The insurance company then reimburses the provider pursuant to the agreed upon terms.

The insurance company benefits by having the ability to lock providers into a fixed fee for service arrangement and reduced claim administration, because of the ability to focus on claim management as opposed to claim processing.

Health care providers will benefit because of the immediate receivables for services and reduced office administration. Policy holders will benefit because of the ability to manage personal health care expenses with less difficulty.

The present System uses a computer network, such as the worldwide computer network, as its communication platform. The provider 20 must have a network connection (which presently usually requires at least a telephone line, a modem and a computer) in order to access the System 45. The faster the modem and computer processor, the faster and better the communication, which is fundamental to real time processing.

The System 45 will be the hub of its own computer network, which may also be a part of a larger computer network, such as the worldwide computer network. The system will also be an “Application Software Provider” as well. The provider will not need to install the software on the provider's personal computer for example, but rather the provider will access the software as it is needed via the world wide communication network. The only data stored on the provider's computer is the connection utility which will be provided by the System.

At the provider's end, the System will run on any computer system that can make an internet connection, but is usually an IBM® compatible PC. An interface will be used to connect with the insurance system.

As used herein the System 45 of the present invention is a combination of programs, data and processes focused on the electronic processing of health claims and the associated payments on behalf of all parties.

The objective of System 45 is to fully process the required transactions, so no further processing is required; this is, once the System has processed a claim, all of the involved parties must be satisfied in their requirements.

Claim adjudication under the present invention will be an automated process performed by the insurance company. An improvement in the present invention is that the insurance company will make claim payments to the provider in asynchronous real-time thus relieving the insurance company from processing payments to the various providers and further alleviating the problems of synchronous real-time processing that occurs in the prior art.

The System allows the patient and the doctor to agree and accept the method of financial settlement. The financial processing (payments, accounts payable and receivables) will be handled in asynchronous real-time by the insurer's system containing software to efficiently process large volumes of financial transactions. This relieves the doctor from follow-up with the client and/or the insurance company in order to collect their professional fees for services rendered.

The claim adjudication process is initiated when the provider submits the super bill to the insurance company. The super bill is routed through the System to the insurance company, which then reviews the super bill, e.g., CPT codes, along with the particulars of the insured patient, along with other additional information from the provider, including the provider's submitted fees in the claim. The insurance company makes a determination of the insurance company's liability and a determination of the patient's liability. If the patient has liability, e.g., the insurance company's policy for the insured patient does not cover in whole or in part the submitted claim, e.g., deductibles, co-payments or uninsurable amounts, the System will then notify the provider in asynchronous real-time so that the provider may collect the patient liability amount directly from the patient.

After the claim is adjudicated and routed through the System 45, the system 45 communicates information of the claim adjudication from the insurance company 30 to the provider advising the provider 20 the following: that the claim is accepted; and that the insurance company owes X dollars and the patient owes Y dollars. In making the latter statement that the patient owes Y dollars the System 45 is representing to the provider 20 that the patient must settle the obligation of Y dollars with the provider.

The next stage is the “settling conference” or the Explanation of Benefits (EOB) between patient 10 and provider 20 whereby the patient and provider must agree on the claim adjudication set forth by the insurance company. There are 3 alternatives. First, the patient and provider agree on the amounts owed by the patient and the amount to be paid by the insurance company. In this event, the provider notifies the System and the System in asynchronous real-time mode advises the insurance company that the patient and provider have accepted adjudication. At that time the insurance company reimburses the provider the amount of X dollars owed by the insurance company. The patient will ultimately reimburse the provider the amount of Y dollars, e.g., the patient's liability. The patient's liability will be paid as the patient desires. Though this transaction as heretofore described happens in asynchronous real-time mode as it is well know in the present art, for example in the Visa® and MasterCard® credit card interchanges, delays of settlement (to the provider) of up to 48 hours are per standard operating procedures of retail credit card transactions.

In the event at the time the claim is reviewed by the insurance company for a claim adjudication and there is insufficient insurance available on the patient's account, then the System will communicate with the provider and the patient in a “settlement conference” as heretofore described. However, in this latter situation, the discussions between the patient and the provider would relate to the reasons for the additional liability against the patient. In this “settlement conference,” presumably the patient and the provider would resolve the differences in the additional liability by either the patient assuming the liability or settled through alternate means.

In the latter situation where there is not an acceptance by the patient and the provider, then a default process will be instituted whereby the claim is manually submitted by the provider directly to the insurance company as part of an established appeals process.

The System will involve four different players in three different physical locations; they are:
The client 10 (and its ID card); the medical facility, provider 20 (clinic, hospital, doctors, etc.); the insurance company 30; and the System interface 45 is the coordination center between the parties.

The locations involved will be the medical facility (client and doctors) the insurance company, and the System.

The System 45 will make possible that all the physical locations stay at least virtually connected and available as needed for the clinic and client to completed a transaction.

Due to the different nature of each location, and the time required to process a transaction, the System will be developed as an “asynchronous” system. That is, each step of the process will wait for the prior step to be completed before continuing with the next step, all of this under the automated control of the System.

In this scenario it is advantageous of the present invention that the System can process transactions that may take from seconds to whole hours to complete without failure. The System will save required information from each transaction to be able to justify the final outcome of the result to each party.

These connectivity requirements make the worldwide computer network the preferred media for communication. The worldwide computer network can be as secure as required, more than regular credit card point of sale (POS) machines and it also provides the required flexibility and cost savings needed for the process of the volume of transactions anticipated to be handled by the System.

The System 45 will work on two separate sets of data, data created by the System while processing transactions, and data that pre-exists in the System before a transaction can be processed.

Pre-existing data will contain: insurance data; credit data; System 45 tables to reflect the various agreements between the insurance companies and the provider; other data used by the System 45 client software; and medical tables like CPT tables.

Transaction Data will include clinic created data, and System created data.

The System interface 45 will have two sets of codes, a client code and a processing code. Client codes will be responsible to interact with the clinic/patient side, print the super bill and the final Explanation of Benefits (EOB). The processing code will receive a request for identification of the patient, submit a request to insurance company, and submit reply to the clinic.

The System 45 is a back office system, in the form of a worldwide computer network web site that will act as the main communicator between the parties and a data repository dedicated to validate and route requests to the insurance company.

The client programs are the user interface used to process the relationship information, create a super bill, submit data to and read data from the back office system; it will also interface with future physicians' office management programs.

The System interfaces with databases stored in the claim administration system at the insurance company. A unique “client identification number” is stored in the relationship information of the client. It is also embossed on the insurance cared. This ID number is used to access the data stored in the insurance company's claim administrating system.

Some data may be temporarily stored in the System (range of policy numbers that are either in force or lapsed, providers participating in the program, etc.), but the data originates at the insurance companies and it is their responsibility to update.

An interface 45i provides an electronic link that allows the System of the present invention to communicate in a compatible computer language to independent systems (the insurance company). Each interface 45i is unique to the System of the present invention and the system that it connects. The interface is a program stored in a powerful personal computer that is physically connected by hard wire to the insurance systems. It is connected to the System Internet Service Provider (ISP) via the world wide computer network.

As used herein, the concept of a super bill is a form which contains the entire patient and payer data before the medical service is provided. It also will contain information on the services rendered and the fees charged. This “form” becomes then an electronic form for the System 45, where it is sent partially to the insurance company for claim adjudication, becoming effectively a “claims form” from the insurance company point of view.

Once received from the insurance company, the super bill is assigned an approval code for the transaction (or a denial) in the form of a reply. This reply is added to the electronic version of the super bill which is received by the System and returned back to the clinic.

Once in the clinic, it becomes a paper form which is printed as a combined clinic form plus insurance company EOB. Once signed by the payer it is considered also as a bill and a receipt.

A client will seek services from a Provider (clinic or Hospital); upon arrival, the client will identify himself with an insurance card issued/registered for the purpose.

The receptionist will engage the card to read and transmit relationship information to the System. Then the client program will communicate with the back office system, which will identify the insurance card and provide the operator with an option list of patients under the card, e.g., spouses or dependents.

The System 45 will also create a super bill form to be used by the doctor as services are provided to the patient.

The super bill generated by System 45 will reflect the contractual terms between insurance company 30 and patient 10, and between insurance company 30 and the provider 20. The agreement between the insurance company and the provider will reflect any preferred provider relationships that may exist, e.g., discounted fees for service arrangements, mode or means of payment. The relationship between the provider and the patient would be the terms of the insurance policy, e.g., co-payments, deductibles and exclusions.

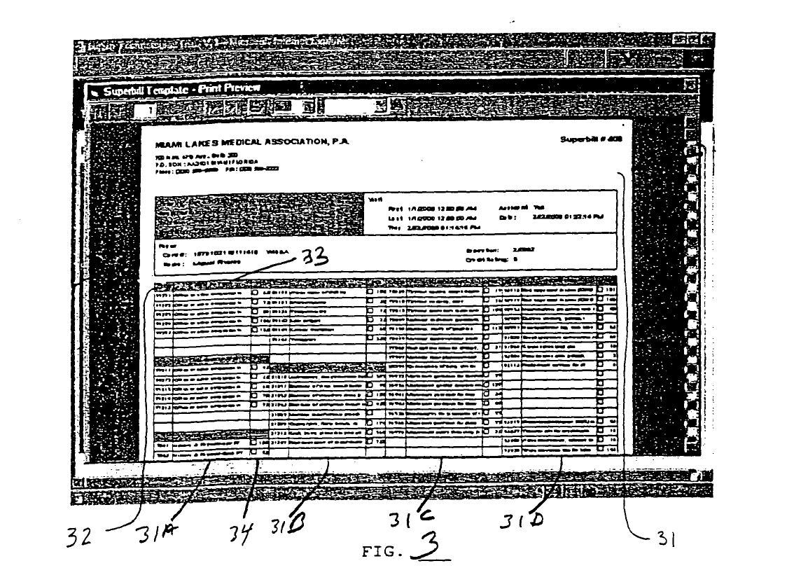

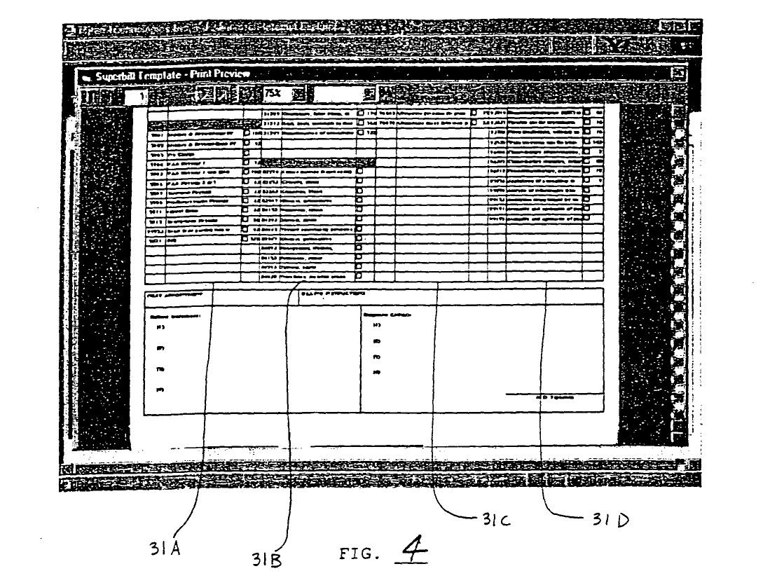

An electronic version of a super bill, number 408, is shown in FIG. 3 on the top half approximately, and the bottom half in FIG. 4. The super bill 31 has four columns A, B, C and D, each column having the CPT code 31, the description 32 and the fee 33 for that description and code. These codes, descriptions and fees would vary depending on the relationship between the insurance company and the provider and between the insurance company and the patient. The present System is able to take current information from those two relationships and provide by printing a hard copy of a new super bill each time a patient starts a service at a provider. Thus, the super bill can reflect the then current terms between the parties in an asynchronous real-time mode. With the super bill tailored to each individual patient, the provider's relationship has more accurate data and can be provided to the provider from the insurance company by the System. Specifically, the super bill will now contain current services provided by the provider that would be covered under the patient's current policy with the insurance company. This will allow, at the time of treatment, current information to both the provider and the patient to determine the desired services and allow the patient and provider to both know their economic risk as to whether those services are covered by the insurance policy. This is not to say that services may be withheld or violate any professional code of ethics of the provider. However, it will make available the economic information and current policy information concerning the providing of these services at the time of performing these services or shortly there before as opposed to a point in time long after the services have been performed as is practiced now in the prior art. Other information contained on the super bill is standard, e.g., the provider's name, the patient's name, etc. and is set forth in FIG. 3 and 4.

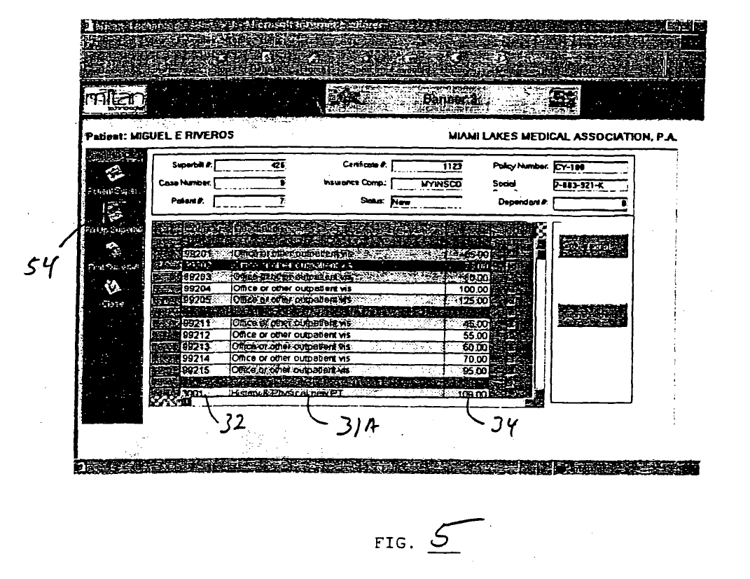

FIG. 5 is a screen, showing the super bill when it is being filled in after the doctor performed services. IN this process column 34 in FIG. 5 shows how the individual line items for each description are selected on the computer electronically. The super bill can be and is preferably completed electronically on the computer screen so that it can be sent electronically from the provider to the insurance company through the System 45.

In the event it is not possible for the provider to send the super bill electronically, an 800 toll free long distance number will be available to verbally transmit the super bill to the System 45.

Once the patient has been serviced, the super bill, now completed by the doctor, will be coded into the client program and submitted to the back office system for processing.

The back office program will read the super bill form and create a “case’ assigning a unique number, which will be returned to the client program to reference this transaction.

The client program will receive a message saying that the request is being processed.

While the client program is notified that the transaction is being processed, the back office system will also communicate with the insurance company and submit a claim to the insurance company.

The back office system waits for the answer from the insurance company which will provide the amounts accepted and covered under the client's insurance, including information on the insurability, deductibles, co-payments, etc.

Once the back office system knows which portions of the super bill the insurance company will cover, the back office system will communicate with the insurance company for payments.

These payments will be allocated as credit payable by the insurance company to the provider. Any debit portion will be billed by the provider to the client under the terms mutually agreed upon by the provider and client. This is the portion covered by the insurance company, net of co-pay and deductible; and debit to the client for the portion of the bill not covered by the insurance company, plus the amount applied to deductibles, plus the co-payments, if any.

Once the insurance company transactions are processed, back office system will reply to the client program and the clinic with the results of the process in the form of an EOB. This EOB will include information on the charges to the client's insurance and if there is cash pending to be paid by the client. The client will sign the clinic's copy of the EOB and will keep a copy for the client's personal records.

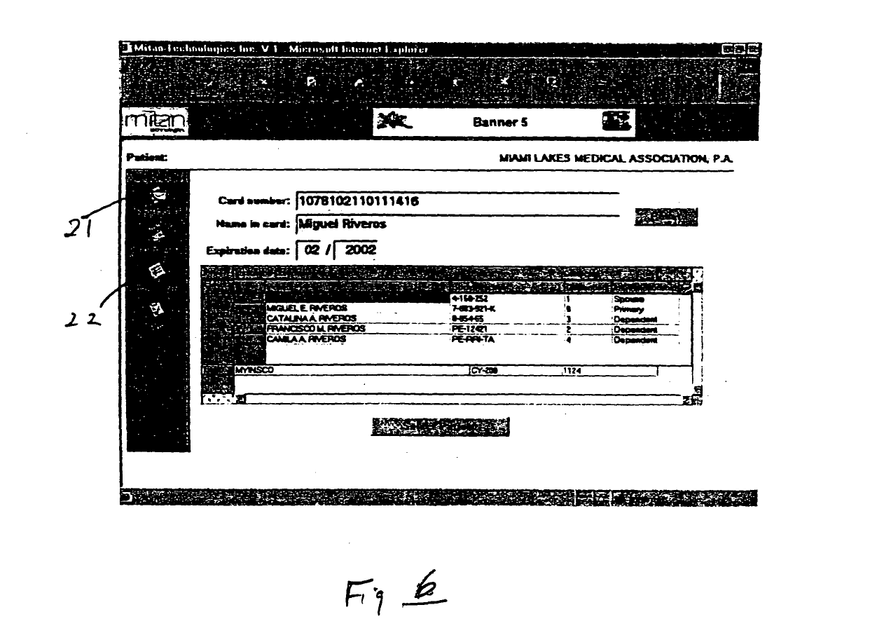

The log-in process on the provider's computer begins typically with a provider (e.g., a doctor's office), who will sign into the System interface on the world wide computer network at the System's web site and clear the provider's password. If the identification is valid, the provider can continue with the process. The System interface will identify the provider from its local database of providers in the System. The System interface will display a working console menu at the provider's computer where all activity will be performed. This console screen FIG. 6 will provide the provider with two main options, first to select a patient 21, that is used when a new person walks into the clinic, and select a super bill 22, used when a patient has been serviced by the doctor and it's time to close and pay the bill.

When a new client, as used herein new client means new patient that day, walks into the provider's office, the provider will select the option “Select Patient”, which in turn will display a screen to enter the patient data. As the patient's insurance card with relationship information contained thereon is swiped or typed, the System will request the name of the payer and date of expiration of the card, name and date are used to validate the card. It can also use the address verification if needed.

A combined security code is created by combining the client card security code with the provider security code. A request is submitted to the back office system to identify the patient. The data passed by the client program to the back office system in this process is: the provider name, the card number from the patient, and the new combined security code. The console user, the operator, will press “SUBMIT” and the request will go to the back office system for card validation and insurability.

The back office system will return a provider number to the client program for the card used. This provider number is defined and given by the insurance company to the provider and will be stored in the back office system.

The back office system will also return to the client program one or more records containing information for the patient or patients under that insurance card. The information returned will be: insurance company ID, policy number, certificate number, dependent number, relationship within the policy (primary, spouse, child, etc.), patient last name, patient first name, patient middle initial, patient social security number, and an error code, if any. The client program will display the list of patients that are covered under the card used, See FIG. 10.

The provider will create a new super bill using the selected patient. The System already requested from the back office system, the primary carrier, if the patient is insured by various carriers, and the order that the carriers will appear in the screen will be from the first to the last carrier. The System will determine which carrier has the priority. In the case a carrier that is not the primary and in the case the policy is in force, the System will not allow the selection of another policy. Also, if the primary carrier's policy is not in force, then the System will allow the use of another policy in the case order established in the back office system for that patient.

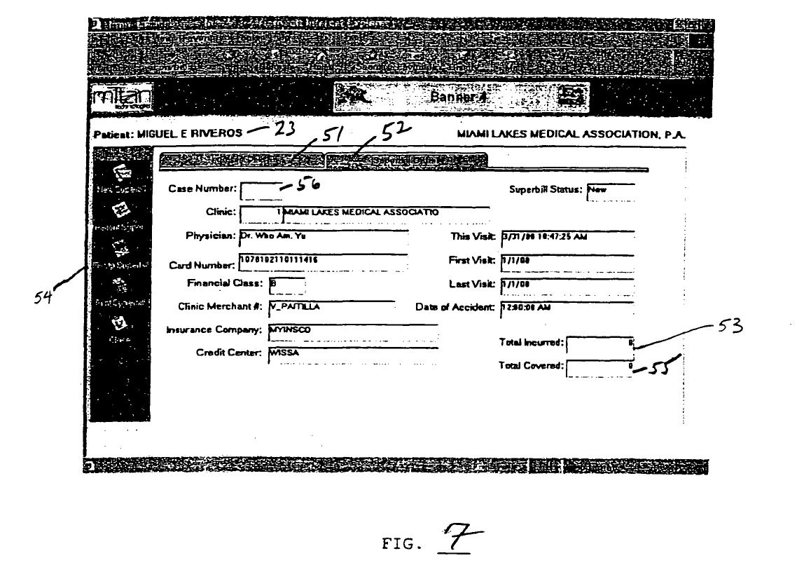

Once a patient has been selected, the working console screen FIG. 7 will display the patient's name 23 in the upper left of the screen. The menu options of the screen will change to reflect the valid options for a selected patient.

The provider will select the patient and a super bill format from a library of super bill templates residing in the client programs. Also, the provider will mark this session as an “accident” or not, this information is required by the insurance company in order to process the claim.

The super bill will contain the patient data and the choice of common CPT codes depending on the template. When a super bill is created from scratch, or when codes are added to it not in the template, that template can be saved for future use.

The customized super bill will be used by the doctor to record the medical services rendered.

Once the super bill has been created, the console screen shows two tabs with information for Patient Detail 51 and super bill Detail, see FIG. 7.

The patient detail tab shows the basic demographic data of the patient. It also carries the last visit date and next appointment. This is restricted to that particular provider only.

The other option is called Patient super bill 53 which, if chose, will display all of the super bills that client has with that clinic, current and past. This acts like a patient historical information list.

If the tab with super bill Detail 52 is pressed, the System will show current information of the recently created super bill.

The fields for Total Incurred 54, Total Covered 55 and Case Number 56 are still empty, this is because a super bill has been created, but not completed and processed.

At this point in the process, the normal option to take is to print the blank super bill which will be made available to the doctor to treat the patient.

The newly created super bill is printed and is passed to the doctor to treat the patient. Two options exist, one to preview the super bill, and the other is to obtain a printed copy of it.

The first part of the printed super bill 31, FIG. 3, is the header which includes information about the patient and the doctor. The second portion of the super bill, FIG. 4, the bottom of the super bill, contains space to be completed by the doctor, for the doctor's notes.

Once the patient has been treated or serviced, the super bill will be returned to the provider's operator for processing. The operator will select the option Select super bill 24. This will list all super bills for that clinic in the status “New”, which are the ones pending to be completed and processed. Once the super bill is identified, the operator will press the button Detail 25 to continue with the fill up and processing of it.

The operator, once having selected super bill, presses the option “Fill Up Super bill 54” to get into this screen. The operator will further select “new” case (the Default) and press “Detail” button, this will take the operator to a screen where the super bill will be completed for approval.

A clinic will have on-line access to all of the cases and the “Super Bills” used in the past, this effectively will become a patient's history record.

A new super bill will include a button “Fill Up Super Bill” where the various codes (CPT) are selected depending on what treatment the doctor has performed.

The operator will enter the various CPT codes and the client program will submit the super bill to the back office system for processing. The user can also save the template (update it), so it can be used in the future.

New CPT codes not in the template, but used by the doctor, can be added by creating a code from the table of possible codes residing in the client program. A super bill cannot be modified by the provider after being submitted.

Once the super bill information is submitted for processing to the back office system, a case number is shown in the screen and a message stating that the super bill has been received by the System is displayed.

The “result” screen of a processed super bill is now completed by the System 45 as the client program will send to the back office system the following information: provider number (clinic number from previous step); smart card number; social security number from the patient; insurance company; policy number; certificate number; dependent number; and the combined security code.

The back office system processes the super bill as follows: initially the transmitted information is validated. If there is an error the system will notify the client program about it. It will also validate that the insurance card submitted is recognized as active and participating in the System 45. It will also validate that the insurance company is actively participating in the System 45. The back office system will open a case and return to the client program the “case” number. This case number will be used from here on to identify the process and it will appear in the user screen.

Each case will contain the following information: provider number; policy number; certificate number; dependent number; insurance company; card number; creation date; and stale date (the later is used to close a case automatically by the back office system after a period of inactivity).

Once a case is created by the back office system, the client program will use this “case” number to: first submit, one by one, the CPT codes and reference fees (clinic fee). For each code the client program will send to the back office system the case number, the CPT code, the amount (charged) incurred; and the combined security code. The back office system will add each line to the open case queue for later processing.

Second, the back office system will start processing of a case, the client program will submit a request with the case number and combined security code.

The back office system will process the case as follows: (Error codes will be issued in each of the following steps if the back office system finds that some information is not acceptable); validate request; read pending cases; queue to see if the case exists; validate that the case has not expired; validate that the case has not been already processed; validate that the provider ID assigned by the System to the clinic exists and is valid; send a “Not Covered” message for each CPT not covered or recognized by the back office system under this policy contract, and prepare a record for each CPT recognized by the insurance contract as: get CPT code from open case queue; get amount incurred from open case; get amount covered from insurance company table (residing in the back office system); get co-payment rules from insurance company 30 table and set co-payment to zero; get deductible indicator from insurance company table and set DEDUCTIBLE to zero; set to zero REFUNDED amount; set to spaces MESSAGE from insurance company; and set to zero the error code.

The following steps recreate a theoretical insurance company. These steps will vary as the real interfaces with real claims are implemented.

Set the COVERED amounts as the minimum between the INCURRED amount and the amount covered by the insurance company for this CPT.

Compute the deductible as the minimum between the Family Deductible, Individual Deductible and the Amount Covered creating the DEDUCTIBLE amount.

Compute the amount PAYABLE as the COVERED-DEDUCTIBLE amount.

Create a claim history record containing: case number; policy number; certificate number; dependent number; CPT code; date incurred; date paid; amount incurred; amount covered; deductible; co-pay amount; and refunded amount.

Update dependent claim history record as: add the amount incurred to the total claimed; add the amount covered to total paid; add deductible paid to total deductible; add the refunded amount to refund total; and add to co-payment total the amount of co-pay.

Update the certificate record with: payable amount; co-pay amount; deductible amount; refund amount; message with “OK. . . ”; and accepted flag with (0=yes, has been accepted by insurance company).

Once each CPT code has been processed, the case will continue processing to produce the charges to the insurance company and the client as needed.

Charge the insurance company for the amount refunded (covered less deductible and co-pay). Skip if the insurance company has recognized no refund.

Create charge to the insurance company, create history record of the request, and find insurance company payment limit.

If the insurance company payment limit is not enough to cover the claim, the System will make a record in the back office system database.

If the insurance company payment limit is sufficient to cover the claim, the process will record the approval code from the insurance company in the back office system database, and create a payable to the clinic.

Charge the client for the amount not covered by the insurance, including the co-pay and deductible amounts as follows: create a charge to the client; create history record of the request in the back office system database; if client chooses to pay by credit card, find if the credit limit of the client is enough to cover its portion of the bill; if the credit line is not enough to cover the bill, record the reject in the back office system database; if the credit line is sufficient to cover the bill; record the approval code from the credit card processor in the back office system database; create account receivable in the back office system; subtract the credit card processor commission from the transaction total; create a payable to the provider (clinic) net of the credit card processor commission; update the pending “case” as fully processed adding a processed date to the “case”.

After the “case” is processed, the client program will request information in a separate menu where all submitted cases have been posted.

The operator will then select the case and request from back office system a final Explanation of Benefits (EOB) which will be printed by the client program and delivered to the provider to be signed by the client/patient. A refresh button will create a status of whether the Claim has been adjusted and the case processed.

The EOB will contain: the insurance company card number and approval code (if charged); the client credit card number and approval code (if charged); the total charges by the clinic; the amount covered by insurance company; the amount charged to client card (if approved); the amount charged to the insurance company card (if approved); cash due by client (if any); balance due by insurance company (if insurance company credit was rejected); (case) number; provider ID (clinic); policy number; certificate number; dependent number; insurance company, CASE open date; CASE expire date; and insurance company name.

Also, the EOB will be an informational line for each treatment: CPT code; amount incurred; amount covered; insurance company process message; and accept/deny code as set by the insurance company. Additional items in the EOB will be social security of patient; provider name (clinic name); patient last name; patient first name; patient middle initial; credit card processor; credit card processor name; payer (card owner) social security number; credit rating; card relationship (primary or additional card, like spouse); payer last name; payer first name; and payer middle initial.

With above-mentioned information, the client program will print a final combined EOB and receipt. A copy will be printed for the client and a copy for the clinic (to be signed by the clinic). The EOB will have two main sections, one for the headings and detail CPT codes, and the second with the payment data.

The follow of the System is generally as follows:

1. get request of information from clinic, process the request and return answer.
a. Validate provider exits in System from participating providers list (provider).
   i. Validate the card submitted against the list of participating cards (option will be to process charge to validate card).
   ii. Obtain the merchant number for the clinic/card association.
b. Get the combined dependents that are registered for this card.

2. Update the System (clinic) patient database, or create if it is new. Do the same if the payer is new, create Payer_Account and Payer_Card.
a. Validate existence of patient. If it is new, create; if not, modify if required.
   i. Obtain the patient's identification number.
   ii. Validate that the patient's name is correctly registered and update if there is a difference.
b. Validate existence of payer. If it is new, create; if not, modify if required.
   i. Create a new payer's account record.
   ii. Create a new payer's identification number.
   iii. Create the payer's card record.
   iv. Obtain the payer's identification number.
   V. Validate that the payer's card “Name” and “Expire Date” are correctly registered and update if there is a difference.

3. Create a new super bill.
a. Obtain the data about the patient, the payer and the clinic information to create a super bill.
b. Insert the data to create a super bill.
c. Set the super bill status to “N” New.
d. Obtain the super bill number for the new super bill created.

4. Generate a “Super Bill Detail Form: for printing and processing.
a. Obtain the Super Bill Template Code.
b. Insert CPT Codes and Headings, in case they have not already been inserted.

5. Update Super Bill Detail Form.
a. Obtain the Super Bill Template Code.
b. Insert new CPT codes.
C. Insert new Headings.

6. Update super bill from queue after process has been completed, submit case number.
a. Update the Super Bill Detail from super bill processing queue.
b. Update the super bill insurance charges FOR payer (D).
c. Update the payer account for new balance due (if insurance company transaction rejected).
d. Update the duper bill charges FOR INSCO (D).
e. Update the payer account for new insurance company balance due (if transaction rejected).
f. Update the super bill FROM THE OPEN_CASE (B).
g. Update the super bill from summary of super bill detail form (E).
h. Charge the super bill status to “R” Received.

7. Present the super bill and its Detail (if present) for printing and update the “Super Bill Status” to (P)rinted, if it applies.
a. Present the super bill and its Detail Form for printing.
b. Update the “Super Bill Status” if it is currently (R)eceived, to (P)rinted.
C. Print a super bill and EOB.

8. Update the “Selected” status of a “Super Bill Detail Form Element” to “(T)rue”.
a. Verify the existence of this super bill detail from element and retrieve its abstract key.

9. Get request to open a new case for processing (step 1 of 3).
a. Validate provider exists in the System participating providers list (provider).
b. Validate the card submitted against the list of participating cards (option will be to process a System Fee charge to validate card).
c. Validate insurance company is participating in the System Plan. Open a new Case and return case number to clinic.
d. Open a new “Case” and return case number to the System.

10. Add CPT plus reference fees from client to case before processing by insurance company (step 2 of 3).
a. Insert into super bill queue the CPT's and FEES's.

11. Submit case for processing to insurance company and charges to credit cards (if required) (step 3 of 3).
a. Send case for processing to insurance company.
   i. Insurance company processing.
   ii. Get provider name.
b. Get merchant number for this credit card, required.
c. Eliminate the not covered CPT's and add the charge to client insurance company.
d. Process CPT's that exist in insurance company plan.
e. Get the lowest between the client reference fee and the insurance company CPT payable amount.
f. Computer deductible accumulation to date.
   i. If no deductible apply (CPT code), then skip.
   ii. Knowing that this CPT is prone to deductible, the pending deductible for this dependent is computed.
g. Find if there is a co-pay for the refund amount as flat dollar amount.
h. Accumulate charges payable by the insurance company.
   i. Update dependent record for statistics.
   ii. Update the super bill_queue of process with all of the computed data.
i. Process required charges and credits for clinic, insurance company and client.
   i. Charges to insurance company for amounts refunded (EOB).
j. Process insurance charge.
   i. Find available insurance line.
   ii. Approval number.
k. Charges to client for amounts not covered by insurance company.
   i. Submit charges to credit card processing center for approval, or client can pay by cash or check.
   ii. Find available credit line, if required.
   iii. Approval number, if required.
l. Update Case as processed.

12. Obtain a list of super bill by super bill_status and clinic_ID.
a. Obtain the Super Bill Template Code.

13. Obtain a list of super bill for specific patient.
a. Obtain Super List by patient_ak, clinic_id and super bill_status.

14. Obtain the information about patient and a super bill detail by a specific super bill number.

15. Obtain a medical procedure for a specific super bill.

16. Obtain the detail for the capture of specific super bill.

17. Obtain a header for the capture of detail for specific super bill.

18. Retrieve the list of super bill template for a specific clinic.

19. Retrieve parameters for a specific clinic.

20. Update a case number of super bill when the detail is being created.

21. Update the status of super bill when the detail has been created and submitted in the capture (filled) of super bill.

Conforming to the provisions of the patent statutes, applicant has provided an explanation of the principle, preferred construction and mode of operation of this invention and has illustrated and described what is now considered to be its best embodiment. It is understood, however, that within the scope of the claimed subject matter that follows, the invention may be practiced otherwise than as specifically illustrated and described, particularly in the numerous aspects of the insurance industry, such as automobile insurance, dental insurance and prescription insurance services.

1. A method for effectuating payment of a service for the benefit of a first party, performed by a second party and facilitated by a third party, comprising:
a. a first party requesting a service from a second party;
b. a first party providing relationship information about said first party's relationship with said third party to said second party;
c. said second party electronically communicating said relationship information to a third party to verify eligibility of said first party;
d. said third party confirming eligibility of said first party in an asynchronous real-time mode and providing a predetermined fee schedule between said third party and said second party for services for said first party;
e. said second party submitting a claim, based on services for said first party, to said third party;
f. comparing said submitted claim to said relationship information concerning said first party's relationship with said third party, and
g. adjudicating said claim in an asynchronous real-time mode and settling said claim by said third party authorizing a transfer of funds to said second party when said compared information is within guidelines established by said third party.

2. A method for effectuating payment of a service as set forth in claim 1 above further comprising:
a. said transfer of funds is for less than the full amount of said claim submitted by said second party, and
b. said second party elects to charge said balance of said submitted claim to said first party.

3. A method for effectuating payment of a service as set forth in claim 1 above further comprising:
a. said transfer of funds if for less than the full amount of said claim submitted by said second party, and
b. said first party elects to pay said second party directly the said balance of said submitted claim.

4. A method for effectuating payment of a service as set forth in claim 1 above further comprising:
said third party has a library of super bills which incorporate said fee schedule, descriptive terminology, and identifying codes for reporting for said services; and
said super bills are in the form of templates which are updated in asynchronous real-time by said third party reflecting current relationships between said second party and said third party.

5. A method for effectuating payment of a service as set forth in a claim 4 above wherein said second party selects one of said super bill templates from aid library and records services performed for said first party on said super bill to be forwarded to aid third party for processing.

6. A method for effectuating payment of a service as set forth in claim 5 above wherein relationship information and information on said super bill is forwarded to said third party from said second party by means of a world wide computer network.

7. A method for effectuating payment of a service for the benefit of a first party, performed by a second party and facilitated a third party comprising the steps of:
a. receiving a request from a first party to perform a service by a second party for said first party;
b. providing relationship information about said first party's relationship with said third party;
c. said second party electronically communicating said relationship information to a third party to verify eligibility of aid first party;
d. said third party verifying said relationship information received from said second party, and providing an electronic authorization to said second party to perform said second party's services according to said third party's obligations to said first party; and
e. said third party authorizing a transfer of funds to said second party for services performed.

8. An apparatus for facilitating payment for services of a first party, performed by a second party and facilitated by a third party comprising:
a. a database on a computer network receiving a request to verify eligibility to perform services on a first party, from a second party;
b. relationship information about said party's relationship with a third party;
c. means for electronically communicating said relationship information about said first party from said first party to said database;
d. said third party verifying in asynchronous real-time said relationship information received from said second party and providing a means for said second party to document said second party's services according to said third party's obligations to said first party;
e. means for said third party to authorize payment in asynchronous real-time to said second party for services performed; and
f. means for notifying said second party about matters not covered by said third party's obligations to said first party.
